(19) United States
(12) Patent Application Publication
(10) Pub. No.: US 2010/0018220 A1
(43) Pub. Date: Jan. 28, 2010

(54) APPARATUS FOR HEATING OR COOLING AND MONITORING CONSUMPTION OF A BEVERAGE

(76) Inventor: Allan A. Modad, Hayward, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/180,443

(22) Filed: Jul. 25, 2008

(51) Int. Cl. F25B 21/02; G01G 23/18; G05B 15/00

(52) U.S. Cl. 62/3.3; 177/45; 700/275

(57) ABSTRACT

An apparatus selectively heats or cools a beverage in a beverage container and indicates an amount of beverage in the beverage container. The apparatus comprises a portable housing having a door opening into a thermal chamber that is well suited for heating or cooling a 16-ounce (370 milliliter) beverage container. A control module controls a thermoelectric cooler to alternatively heat or cool the beverage. A scale weighs the beverage container and beverage and outputs a value related to a weight of beverage in the container. A display module optionally displays time and weight data related to beverage consumption. The thermoelectric cooler may optionally be controlled to reduce audible noise or to reduce energy consumption. A flexible arm and tubing clip hold a drinking straw in a convenient position for drinking. Power for the apparatus may optionally by supplied by an AC-to-DC converter with a 12 VDC output or from a 12-volt battery.

### FIELD OF THE INVENTION

The present invention relates to an apparatus for heating or cooling a beverage and for measuring an amount of beverage in a container placed in the apparatus.

### BACKGROUND

It is well known that the regular consumption of fluids is an important part of maintaining good health. It may also be necessary for a person to consume a beverage comprising a medication in fluid form for diagnostic, therapeutic, or preventative reasons. Medical procedures may call for a beverage to be consumed within a specified period of time. It may also be desirable, for example for reasons of medical effectiveness or palatability, to maintain the temperature of a warm beverage above a threshold temperature or to maintain the temperature of a cool beverage below a threshold temperature.

Some persons are willing and able to follow instructions for maintaining beverage temperature and for the times and amounts of consumption. Others may fail to follow such instructions because of lack of suitable heating or cooling equipment, poor comprehension, limited mobility, impaired memory, or other reasons. Care providers may therefore need to verify that beverages are consumed as prescribed, especially for patients who are unable to care for themselves. Unfortunately, in facilities with many patients, it can be difficult for care providers to keep different kinds of beverages within a preferred temperature range for each kind of beverage while managing the amounts and times of beverage consumption for individual patients. Furthermore, distributing beverages to patients may require many trips between hot beverage or cold beverage preparation or storage locations and individual patient locations. Repeated trips may be necessary to reheat or re-cool a beverage whose temperature changes too much during distribution or consumption. More trips may be needed to determine if each patient has consumed a specified amount of beverage in a required amount of time.

Floor space limitations, the expense of dedicated facilities, the availability of electrical power connections having sufficient current capacity, and potentially disruptive noise are some disadvantages of using conventional refrigerators and ovens for maintaining stores of beverages close to patient locations. An insulated cart or carrier may maintain a beverage near a desired temperature during transport but it may not be possible to leave the cart or carrier with a patient. Even if the insulated cart or carrier is left with a patient, some patients may not be relied on to keep the beverage in the carrier to maintain the beverage's temperature, or once the beverage is out of sight in the carrier, may fail to withdraw it for consumption.

What is needed is an apparatus that heats or cools a beverage, is portable, and is small enough to place in close proximity to a patient. What is further needed is an apparatus that provides an indication of an amount of beverage consumed. What is further needed is an apparatus that provides a reminder that beverage remains to be consumed.

### SUMMARY

The present invention relates to an apparatus for heating or cooling a beverage in a beverage container and for measuring an amount of beverage in the container. Embodiments of the invention comprise a portable housing having within a temperature chamber for holding a beverage container. A beverage in a beverage container placed within the temperature chamber is selectively heated or cooled by a thermoelectric cooler (TEC) that is thermally coupled to a wall of the temperature chamber.

A tubing port passing between a top surface of the housing and the temperature chamber permits fluid to be removed from the beverage container. A scale having a weighing surface in the temperature chamber measures a combined weight of the beverage and beverage container. Positioning features on the door assembly and the bottom of the temperature chamber cause the beverage container to rest in a preferred position on the weighing surface of the scale.

A plurality of status indicators communicates information about the apparatus and the beverage to a person using the apparatus, for example a patient or a caregiver. One or more status indicators may optionally be configured to alert a person to consume more beverage. Furthermore, status indicators may optionally be configured to alert a caregiver to an amount of beverage remaining, a rate of beverage consumption, and the operational status of the apparatus, for example whether the TEC is operating in heating mode or cooling mode. Some embodiments include an audio indicator capable of producing different sounds corresponding to different status conditions.

One of the status indicators is a display module adapted to show a numerical value of weight measured by the scale. Other information that may optionally be shown on the display module includes time and temperature values. Time values may optionally include ordinary clock time, a time interval since a full beverage container was placed within the temperature chamber, a time when a container is first detected to be nearly empty of beverage, a rate of beverage consumption, and time remaining in a selected time interval for the consumption of the entire contents of a beverage container. Temperature values may optionally include a value related to a temperature within the temperature chamber or a value representing a selected equilibrium temperature. The display module may optionally display symbols representative of a fraction of a full container's volume or weight.

An electrical switch mounted on the exterior of the housing may be used to select heating mode, cooling mode, or to turn the apparatus off. In cooling mode, a control module adjusts current flowing through the TEC to cause part of the TEC to become cold. In heating mode, current flowing through the TEC is adjusted to cause part of the TEC to become hot.

Embodiments of the invention may optionally receive input electrical power from an external alternating current (AC) to DC power module for converting current and voltage from the AC mains to DC output current at 12 volts. Other external sources of 12 volt DC power may optionally be used with embodiments of the invention, for example a 12 volt battery for an automobile or a 12 volt battery for an electric wheelchair. A battery compartment in the housing holds batteries to provide power to selected components when an external DC power source is disconnected.

Some embodiments include a flexible arm to hold a drinking straw at a convenient drinking position. The flexible arm attaches to the housing and may be bent into a desired shape to position the drinking straw. The drinking straw is supported from the flexible arm by a tubing clip removably attached to the flexible arm and to the drinking straw. An optional, removable cap for the tubing port has an aperture sized for a slidable fit of a drinking straw and facilitates guiding a straw into a beverage container inside the temperature chamber.

This section summarizes some features of the present embodiment. These and other features, aspects, and advantages of the embodiments of the invention will become better understood with regard to the following description and upon reference to the following drawings, wherein:

### BRIEF DESCRIPTION OF THE DRAWINGS

FIG. 1 is a pictorial view of an embodiment of the invention.

FIG. 2 is a top view of the embodiment of FIG. 1.

FIG. 3 is a partial front view of the embodiment of FIG. 1, with the door assembly removed to give a view of the temperature chamber.

FIG. 4 is a side view of the embodiment of FIG. 1, showing an example of a beverage container in a preferred position for being weighed by the scale.

FIG. 5 is a partial sectional view of the embodiment of FIG. 1. The location and viewing direction for the partial sectional view is marked by a line A-A in FIG. 2.

FIG. 6 is a simplified block diagram of an embodiment of the invention.

FIG. 7 is a side view of an example of a flexible arm for holding a drinking straw in a convenient position for drinking.

FIG. 8 is an end view of the flexible arm of FIG. 7.

FIG. 9 is a pictorial view of an example of a tubing clip for removably connecting a drinking straw to a flexible arm.

FIG. 10 is a top view of an example of a mounting bracket for attaching a flexible arm to an outer surface of the housing of an embodiment of the invention.

FIG. 11 is a side view of the mounting bracket of FIG. 10.

FIG. 12 is a top view of a removable cap for covering a tubing port.

FIG. 13 is a sectional view of the cap of FIG. 12. The location and viewing direction for the sectional view are indicated by a line marked B-B in FIG. 12.

FIG. 14 is a pictorial view of an embodiment of the invention comprising a flexible arm having a tubing clip adapted for holding a drinking straw, the flexible arm attached to a mounting bracket on a top surface of a housing. FIG. 14 further illustrates a cap covering the tubing port on a top surface of the housing and shows an example of a drinking straw passing through an aperture in the cap, the straw connected to the flexible arm with the tubing clip. The illustrated positions of the flexible arm and drinking straw are examples of a plurality of alternative optional positions.

### DESCRIPTION

Embodiments of the invention include an apparatus for heating or cooling a beverage in a beverage container and indicating an amount of beverage in the beverage container. Embodiments of the invention are particularly well suited for heating or cooling and measuring an amount of beverage in a sixteen-ounce (370 ml) beverage container, although other sizes of beverage container may also be used. Some of the benefits of the embodiments of the invention include, but are not limited to, portability, safety, ease of set-up, ease of monitoring of a beverage amount, maintenance of a beverage temperature above or below a selected limiting temperature, easy access to a beverage held within the apparatus, energy efficiency, and indication of inadequate beverage consumption. Other benefits include monitoring of beverage consumption per unit time and visual and optionally audible reminders to consume more beverage.

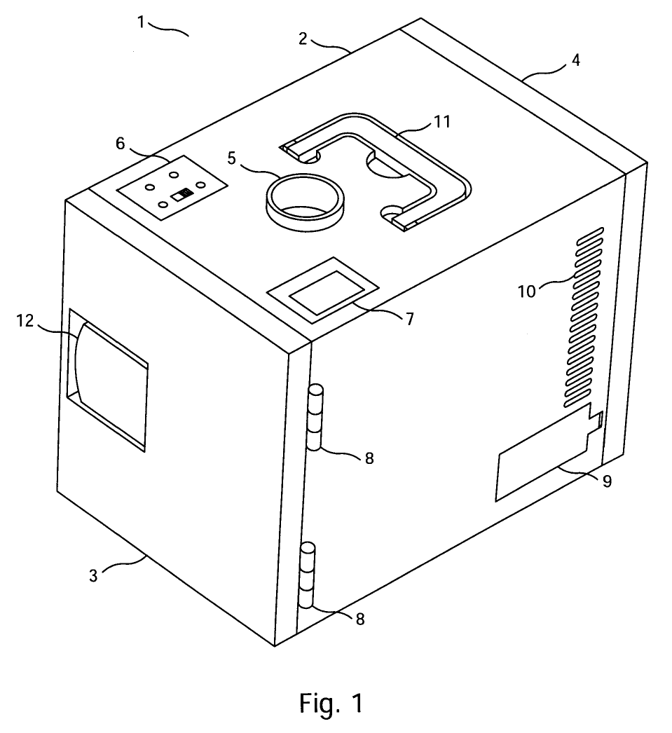

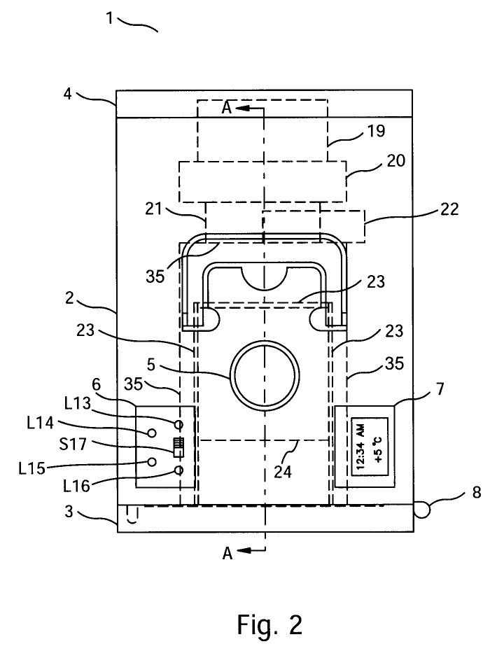

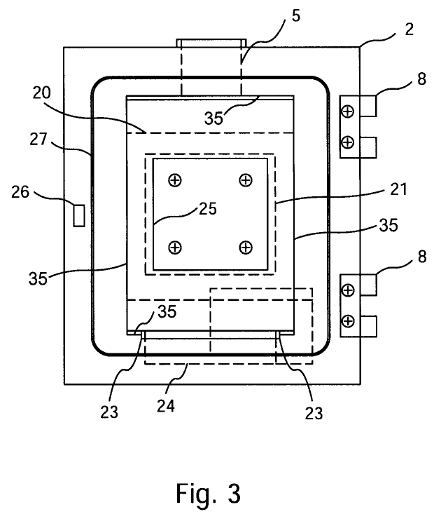

A pictorial representation of an example of an embodiment of the invention is shown in FIG. 1. The embodiment 1 of FIG. 1 comprises a housing 2 having a door assembly 3 attached by a pair of hinges 8 at a front end of the housing and a rear panel 4 attached to the housing at an end opposite the door. Interior surfaces within the housing 2 define the boundaries of a temperature chamber (not visible in FIG. 1, see FIGS. 2-3 and related discussion below) for holding a beverage in a beverage container. In one embodiment, the combined size of the housing 2, rear panel 4, and door assembly 3 in a closed position is approximately 11.0 inches (280 mm) length by 7.4 inches (188 mm) width by 8.4 inches (213 mm) height, and weights less than 15 pounds (7 kilograms). Other embodiments may optionally have different length, width, and height dimensions and a different weight compared to the embodiment of FIG. 1.

A latch mechanism, a part of the door assembly 3, holds the door firmly against the housing 2 when the door assembly 3 is closed. Lifting a latch handle 12 opens the door assembly 3 and gives access to the temperature chamber within the housing 2. A handle 11 is provided for convenience in carrying the apparatus. The handle 11 folds into a recess in the top surface of the housing 2 when the handle is not in use. A battery compartment cover 9 protects a receptacle and electrical connections for one or more back up batteries for powering some electrical components when DC power from an external source is unavailable. Cooling air flows into the housing through two groups of perforations 10, one of each group on opposite sides of the housing 2. Air flows out of the housing through a group of perforations (not visible in FIG. 1) in the rear panel 4.

A tubing port 5 passes through the upper surface of the housing 2 and into the temperature chamber within. As shown in FIGS. 2-4, the tubing port comprises a raised circular rim on a top surface of the housing 2 and walls surrounding a cylindrical opening between the top surface and the temperature chamber. The walls of the tubing port may optionally be formed as part of a temperature chamber liner. A removable cap for covering the tubing port 5 may optionally be attached to the raised circular rim of the tubing port 5.

Beverage is withdrawn from a beverage container located in the temperature chamber through a fluid removal tube inserted into the beverage container through the tubing port 5. A fluid removal tube may be, for example, a drinking straw or a tube connected to an apparatus with a pump. The fluid removal tube may optionally be made from a flexible material or may optionally be formed from a rigid material into a selected shape. Although examples herein generally refer to a drinking straw for removing beverage from a beverage container in the temperature chamber, one will appreciate that other types of fluid removal tubes may optionally be used in place of a drinking straw. Furthermore, although examples herein generally refer to fluid being removed from a beverage container in the temperature chamber, one will also appreciate that fluid may optionally be added to the beverage container through tubing passing through the beverage port 5.

Embodiments of the invention comprise a plurality of status indicators to show an operating condition of the apparatus. Other status indicators may optionally be included to present a user of the apparatus, for example a patient or a caregiver, with information related to a beverage inside the temperature chamber or a time interval of interest. For example, one or more status indictors may be activated to remind a person using the apparatus to consume more fluid or to consume a selected amount of fluid in a selected time interval. Status indicators comprise, but are not limited to, a display module adapted for display of symbols, text, or numbers, for example a liquid crystal display or other dot-addressable or character-addressable display, a discrete indicator such as a light emitting diode (LED), and a sound emitter such as piezoelectric emitter, speaker, or buzzer.

An indicator panel 6, visible on an upper surface of the housing 2 in FIG. 1, includes at least one switch to control the operation of the apparatus and a plurality of status indicators to indicate status of the apparatus and optionally to indicate an amount of beverage in the beverage container. A display module 7, also located on an upper surface of the housing 2, displays numeric and optionally symbolic information related to operating status, time, and an amount of beverage in a beverage container. In some embodiments, the display module 7 includes one or more indicator lights for showing status of parameters not represented on the indicator panel 6. Some embodiments place status indicators on more than one indicator panel, for example to separate status indicators into functional groupings or because of space limitations on the housing.

An amount of beverage may be shown, for example, by one or more status indicators for showing an empty container as a container having a weight less than a first threshold value of weight. One or more status indicators may optionally show a weight between the first threshold value of weight and a second threshold value of weight as a container having only a small amount of beverage remaining. Furthermore, one or more status indicators may optionally show a weight above the second threshold as a beverage container with beverage available for drinking. An indicator for showing a weight of beverage above the second threshold value of weight may optionally be used as a reminder to a person using the apparatus to drink more beverage.

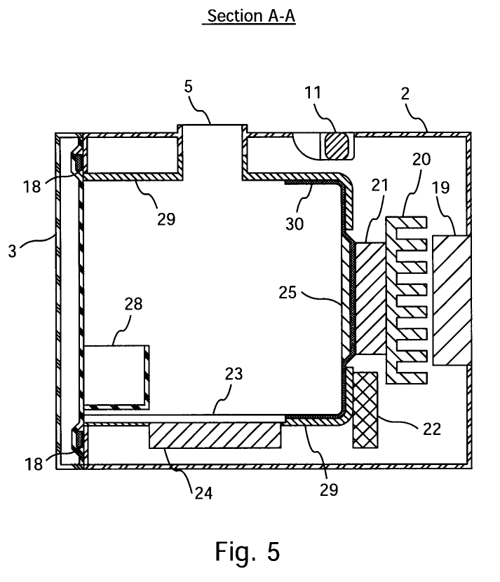

FIG. 2 and FIG. 3 show orthogonal views of the embodiment 1 of FIG. 1. FIG. 2 is a top view showing examples of positions for some components inside the housing 2. FIG. 3 is a partial front view of the embodiment of FIG. 1 with the door assembly 3 removed to show a temperature chamber within the housing. In FIG. 2 and FIG. 3, interior walls 35 form a portion of the sides, back, top, and bottom of the temperature chamber. The weighing surface of a scale 24 is visible under the tubing port in FIG. 2 and along the bottom of the temperature chamber in FIG. 3. The tubing port 5 is shown in FIG. 3 passing from the top surface of the housing 2 into the temperature chamber. Another view of a tubing port is shown in FIG. 5, in which part of the tubing port 5 may be seen to be formed as part of the housing 2 and another part of the tubing port is formed as part of the temperature chamber liner 29.

The outline of a fan 19 is shown toward the rear of the housing 2 in FIG. 2. A heat sink 20 is located between the fan 19 and a TEC 21. The TEC 21, sometimes referred to as a Peltier cooler, is a device having a surface which may selectively be caused to heat or cool by selecting a polarity of current in power supplied to the device. A control module 22 is located between the rear wall 35 of the temperature chamber and the rear cover 4, near the TEC 21, heat sink 20, and fan 20. The control module 22 controls a direction and a magnitude of current flowing to the TEC 21, thereby controlling whether the TEC 21 is in heating mode or cooling mode and correspondingly causing a beverage in the temperature chamber to approach a selected equilibrium temperature.

A TEC mounting plate 25 is visible in FIG. 3 on the rear surface of the temperature chamber. The TEC mounting 25 plate attaches to the TEC 21 with a plurality of fasteners, compressing the TEC 21 against the rear surface of the temperature chamber to facilitate transfer of thermal energy between objects in the temperature chamber and the TEC 21. After the door assembly 3 is closed and an operating mode is activated, the temperature of a beverage inside the temperature chamber gradually approaches an equilibrium temperature related to the temperature of the TEC 21.

A raised door seal lip 27 surrounds the opening to the temperature chamber in FIG. 3. The door seal lip 27 contacts a gasket in the door assembly 3 to for a seal between the door assembly 3 and the housing 2. A door seal gasket 18 in the door assembly 3 is shown in the cross-sectional view of FIG. 5. A latch post 26 is also visible in FIG. 3 near the left side of the housing 2. A latch mechanism in the door assembly 3 couples to the latch post 26 to hold the door assembly 3 against the housing 2.

Three guide rails 23 are positioned on the bottom surface of the temperature chamber. The guide rails 23 cause a beverage container placed within the temperature chamber to come to rest on the weighing surface of the scale 24 so that the beverage and beverage container may be weighed accurately. In the example of FIG. 3, the guide rails 23 have a size and position to cause a 16-ounce (370 ml) beverage container to be approximately centered under the tubing port 5.

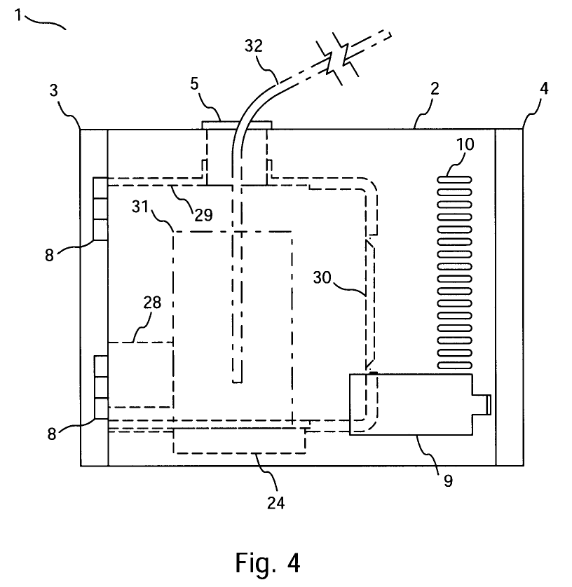

A side view of the embodiment 1 of FIG. 1 is shown in FIG. 4. FIG. 4 further illustrates an example of a position of a beverage container 31 and a drinking straw 32 inside the temperature chamber. An outline of the beverage container 31 is shown above and in contact with the weighing surface of the scale 24, under the tubing port 5. The drinking straw 32 is shown passing through the tubing port 5 and into the beverage container 31. The size and shape of the temperature chamber holding the beverage container 31 is defined in part by the position of a temperature chamber liner 29, the thermal transfer plate 30, and an inside surface of the door assembly 3. The rear cover 4, airflow vents 10, and battery compartment cover 9 are also visible in FIG. 4.

A container positioning guide 28 attaches to an inside surface of the door assembly 3. As shown in FIG. 4, closing the door assembly 3 causes the container positioning guide 28 to push the beverage container 31 until the beverage container 31 comes to rest on the weighing surface of the scale 24. Two guide rails 23 (visible in FIG. 2 and FIG. 3) cooperate with the container positioning guide 28 to push the beverage container 31 into a preferred position for accurate weighing by the scale 24. A number and location of guide rails and a size and shape of the container positioning guide are selected to cause a beverage container to rest in a preferred position above the scale 24. A preferred position for the beverage container 31 on the scale 24 is a position wherein the scale 24 weighs accurately and an end of the drinking straw 32 is positioned in the beverage container 31 for withdrawing beverage from the container. Some embodiments have a number and position of guide rails adapted for a preferred position of a beverage container having a different size or shape than the example of a beverage container shown in FIG. 4.

Some internal features are shown in more detail in FIG. 5, a partial sectional view of the embodiment 1 of FIG. 1. The position of the cutting plane and viewing direction for the sectional view A-A of FIG. 5 is shown by a line marked A-A in FIG. 2. Section A-A in FIG. 5 cuts through the front door assembly 3, the housing 2, the temperature chamber liner 29, the TEC mounting plate 25, the TEC 21, the heat sink 20, the fan 19, and the control module 22. The scale 24 and handle 11 are also shown in cross-section. The container positioning guide 28 attaches to an inner surface of the door assembly 3 in FIG. 5. A door seal gasket 18, shown near the top and the bottom of the door assembly 3, contacts the door seal lip 27 shown in the front view of FIG. 3.

A thermal transfer plate 30, made from a thermally conductive material such as an alloy of aluminum, an alloy of steel, or an alloy of copper, and optionally coated to resist degradation from exposure to beverages and cleaning fluids, contacts a portion of the upper, rear, and lower surfaces of the temperature chamber liner 29. Part of the thermal transfer plate 30 projects through an aperture in the back of the temperature chamber liner 29. A surface of the TEC 21 is pressed firmly against a back surface of the thermal transfer plate 30 by a compression force generated by fasteners connecting the TEC 21 to the TEC mounting plate 25. Firm contact between the TEC 21 and the thermal transfer plate 30 reduces the thermal resistance for thermal energy flowing between these components. A thin layer of thermal transfer compound may optionally be placed between the thermal transfer plate 30 and the TEC 21 to further reduce thermal resistance. The thermal transfer plate increases a surface area available for exchanging thermal energy between air and objects inside the thermal chamber and the TEC 21, thereby increasing a rate at which objects in the thermal chamber approach a set point temperature determined by current flowing between the TEC 21 and the control module 22. The thermal transfer plate 30 therefore increases an efficiency of heating or cooling and results in a corresponding reduction of electrical energy consumption to achieve a selected set point temperature.

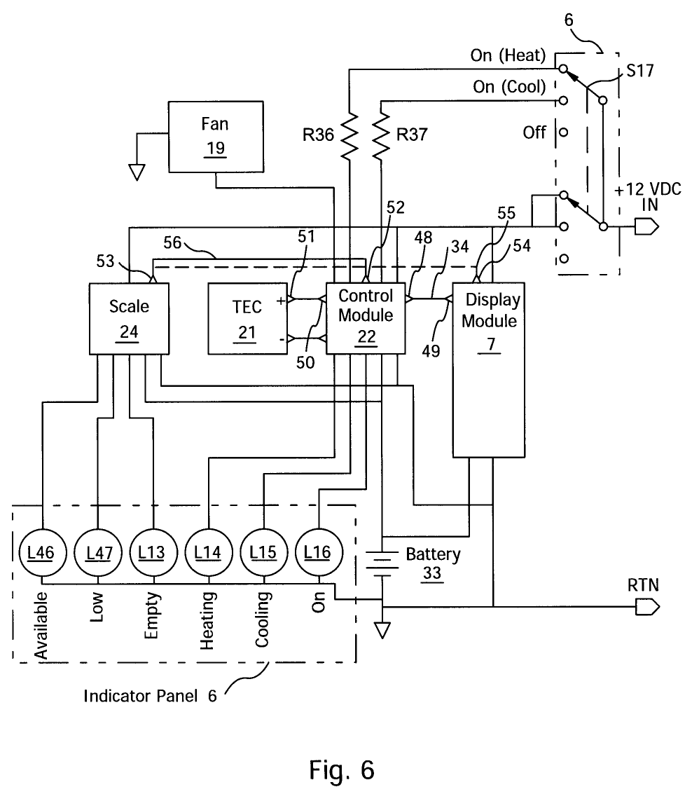

FIG. 6 shows a simplified block diagram of electrical connections between the main functional elements in an embodiment of the invention. A control module 22 controls many operating functions. The control module 22 comprises a data output terminal 48 adapted to carry an electrical signal representative of data to be displayed by a display module 7. The display module 7 has a data input terminal 49 for receiving a signal representative of data to be displayed. An electrical connection between the data output terminal 48 and the data input terminal 49 is represented by a data line 34 in FIG. 6. In some embodiments, data line 34 is representative of a plurality of lines forming a data bus.

As previously explained, a direction and magnitude of current flowing between the control module 22 and the TEC 21 determines whether the TEC 21 operates in heating mode or cooling mode, and further determines the steady-state temperature for objects in the temperature chamber (beverage in a beverage container, for example). Referring to FIG. 6, a selected position of a switch S₁₇ places the apparatus in heating mode, cooling mode, or turns the apparatus off. One or more TEC current terminals 50 on the control module 22 are electrically connected to corresponding supply current terminals 51 on the TEC 21. A direction of current flowing on lines connecting the TEC current terminals 50 to the supply current terminals 51 determines whether the TEC is operating in heating mode or cooling mode.

Input power at 12 VDC from, for example, an external battery or a 12V AC to DC converter, flows in through a connector, through switch S₁₇, and into components such as the scale 24, control module 22, and display module 7. One of pull up resistors R36 and R37 is selected by switch S17 to set control module 22 and TEC 21 into either heating mode or cooling mode. In alternative embodiments, mode control inputs on the control module 22 are set with pull-down resistors instead of pull-up resistors. Optionally, separate switches may be used to turn power on or off and to select heating mode or cooling mode. Some embodiments include a separate switch for independent control of power and tare functions for the scale 24.

Power to a cooling fan 19 passes through the control module 22. In some embodiments, the fan 19 runs continuously whenever the apparatus is turned on. In other embodiments, the control module 22 controls an amount of power supplied to the fan 19 to reduce audible noise. Noise reduction is advantageous when an embodiment of the invention is used in a room where low noise levels are preferred, for example a hospital room or a bedroom. An amount of power supplied to the fan 19 may be controlled by, for example, controlling an amount of current supplied to the fan, controlling a magnitude of voltage supplied to the fan, and switching the fan on and off according to a selected duty cycle. One skilled in the art will be familiar with these and other methods for controlling fan noise. In some embodiments, the control module 22 uses similar techniques to control the fan 19 and the TEC 21 to reduce an amount of energy consumption by the fan 19 and the TEC 21.

In the example of FIG. 6, status indicators comprise a plurality of indicator lights and a display module. Indicator lights L14, L15, and L16 on the indicator panel 6 are driven from the control module 22 to give a visual indication of the operating state of the apparatus. For example, placing switch S17 to On (Heating) causes indicator light L14 to illuminate. Placing switch S17 to On (Cooling) turns on indicator light L15. In some embodiments, the functions of indicator lights L14 and L15 may be optionally be combined in a single indicator light capable of producing more than one color, changing from steady to flashing illumination, or a combination of flashing and color change. Some indicator lights may optionally be included with a display module 7 instead of the indicator panel 6.

In some embodiments, an indicator light L13 on the indicator panel 6 is driven from an output of the scale 24. The scale 24 also outputs an electrical signal representative of a value of a weight measurement on a weight data output terminal 53. A weight data line 56 is electrically connected to the weight data output terminal 53 and to a weight data input terminal 52 on the control module 22. The weight data output terminal 53 on the scale 24 may optionally be connected to a weight data input terminal 54 on the display module 7. Indicator light L13 illuminates when a weight of beverage in a beverage container placed on the scale 24 is less than or equal to a first threshold value representing an empty or nearly empty container, for example a weight corresponding to a volume of 0.5 ounce (14 ml) of beverage. The control module 24 may direct the scale 24 to flash indicator lamp L13 to instruct a user to place an empty beverage container on the scale 24. After the scale 24 measures the empty weight of the container, also known as the tare weight of the container, indicator light L13 may be turned off to indicate that a full beverage container may be placed on the scale 24. After the beverage has been consumed, indicator lamp L13 may optionally be illuminated to indicate that the beverage container is empty.

In some embodiments, other indicator lights illuminate to indicate an amount of beverage remaining in a beverage container. For example, indicator light L47 in FIG. 6 may optionally be illuminated when a weight of beverage is less than or equal to a second threshold value representing a container with only a small amount of beverage remaining, for example a weight corresponding to a beverage volume of 2 ounces (60 ml), and more than the first threshold value representing an empty container. A third indicator light L46 may optionally be illuminated when an amount of beverage remaining is greater than the second threshold, thereby indicating that a substantial amount of beverage is available for drinking. The first and second threshold values may optionally be set to different values than those in the preceding examples.

Other status indicators show an operating condition of an embodiment. In the example of FIG. 6, a heating mode indicator light L14 illuminates when On (Heat) is selected with switch S17. A cooling mode indictor light L15 illuminates when On (Cool) is selected with switch S17. The control module 22 may optionally turn off lamps L15 and L16 when current between the control module 22 and the TEC 21 is not flowing. A power indicator lamp L16 illuminates to show that the apparatus is operating.

The display module 7 displays numeric, and optionally symbolic, representations of data. Examples of data to be displayed on the display module 7 include, but are not limited to, data related to time, weight of the beverage in the beverage container, weight of the beverage container alone, combined weight of the beverage and the beverage container, temperature of the temperature chamber, and temperature of the beverage. Examples of data related to time include, but are not limited to, clock time (i.e., time as displayed by an ordinary watch or clock), a target time interval over which the beverage in the beverage container is to be consumed, an elapsed time since a full beverage container was placed in the temperature chamber, and a time when almost all of the beverage in a beverage container has been removed. The display module may optionally show symbols corresponding to units of measurement and may optionally show other symbols representative of an amount of beverage corresponding to a fraction of a full beverage container, for example a bar graph, pie chart, or similar graphic representations of fractions. The display module may optionally show temperature data related to the TEC, the temperature chamber, or a beverage in the temperature chamber.

In some embodiments, the control module 22 receives weight data from the scale 24 on an optional weight data line 56. The control module 22 may optionally combine weight data and time information to cause the display module to show, for example, ordinary clock time, time elapsed since a full beverage container was last placed in the apparatus, time when the beverage container attained a weight representing an essentially empty container, weight of beverage consumed over a selected time interval, a rate of beverage consumption per unit time, for example ounces per hour, or time remaining until the beverage in the beverage container is to be fully consumed. One will appreciate that other data related to time, weight, and temperature values may optionally be displayed by embodiments of the invention.

A battery 33 may optionally be connected to the display module 7, control module 22, and scale 24 to cause data to be retained when DC input power is removed from the apparatus. The battery 33 may enable the scale 24 to retain a value for tare weight, for example, and for the display module 7 or control module 22 to retain values related to time or other parameters.

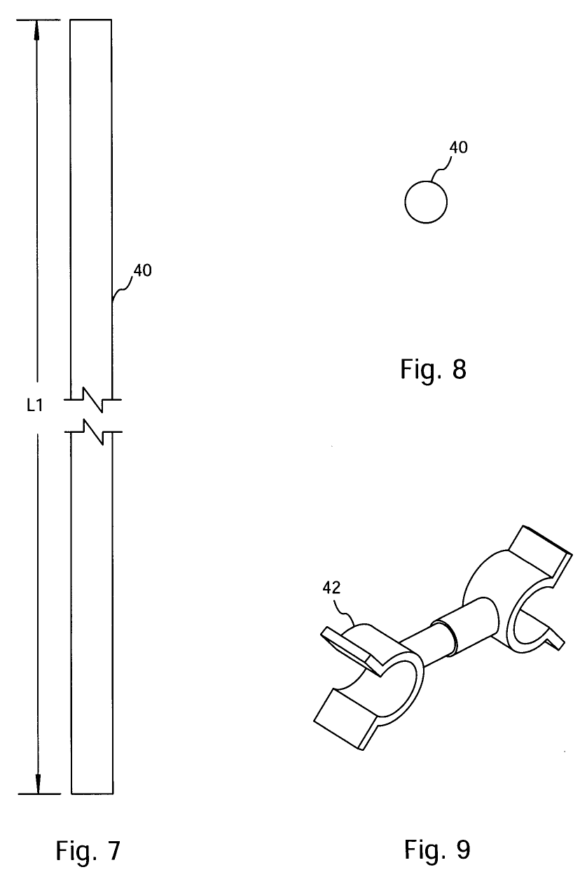

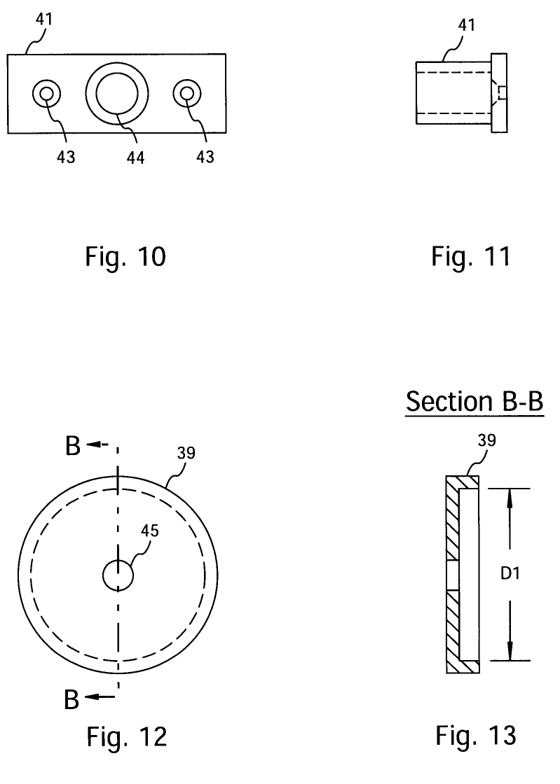

A flexible arm for positioning a drinking straw may optionally be included with some embodiments. The flexible arm, sometimes referred to as a “gooseneck”, comprises a spring steel core covered with a flexible material such as vinyl. A flexible arm generally has a cylindrical shape, as in the side view of FIG. 7 and the end view of FIG. 8, and may easily be manually bent into a selected shape. A flexible arm may be specified with a selected length (marked “L1” in FIG. 7), amount of stiffness, load carrying capacity, minimum bend radius, and means for attaching the arm to other structures. In some embodiments, a flexible arm comprises a mounting bracket removably, or optionally permanently, attached to a first end of the arm. In other embodiments, as in FIG. 7 and FIG. 8, a flexible arm is attached to a mounting bracket as in the top view of FIG. 10 and the side view of FIG. 11, and the mounting bracket is attached to a housing or other support structure.

A tubing clip attaches a drinking straw to a flexible arm at a selected position on the flexible arm. FIG. 9 is a pictorial illustration of an example of a tubing clip 42. The tubing clip 42 comprises a first clip at a first end and a second clip at a second end. The first clip has a size selected to enable removable attachment to a flexible arm, for example the flexible arm 40 of FIG. 7. The second clip may optionally be the same size as the first clip or may optionally have a size selected for removable attachment of a drinking straw or other tubing for carrying fluid. More than one tubing clip may optionally be used to attach a drinking straw to a flexible arm.

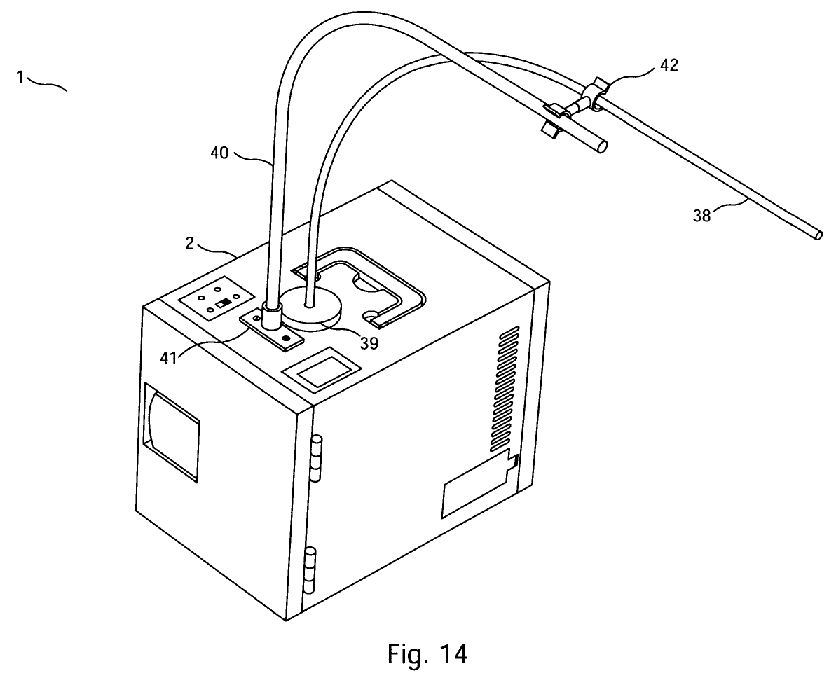

A flexible arm 40, mounting bracket 41, tubing clip 42, and drinking straw 38 are shown in one of many optional positions in FIG. 14. The flexible arm 40 is attached with a bracket 41 to the top surface of the housing 2 of the embodiment 1. The bracket may optionally be attached to the housing 2 with threaded fasteners, adhesive, welding, or may optionally be formed as part of the housing or flexible arm. The flexible arm 40 may be bent manually to a selected position; in FIG. 14 the arm has a simple bend to the right. After bending, the flexible arm retains its shape until the arm is selectively bent again. The flexible arm 40 may be bent and twisted into many different curved shapes so as to position an end of a drinking straw in a convenient position for drinking.

In FIG. 14, a tubing clip 42 removably attaches a drinking straw 38 to the flexible arm 40. The tubing clip 42 holds the drinking straw 38 in a convenient position for drinking. A cap 39 further facilitates holding the drinking straw 38 in position for drinking. The cap 39 has a generally cylindrical shape, as shown in FIG. 12 and the sectional view of FIG. 13, and has a diameter D1 adapted for a removable fit over the rim of a tubing port. An example of a tubing port 5 having a rim is visible in FIG. 1, FIG. 2, and FIG. 4. The cap 39 is formed with an aperture 45 sized for a slidable fit of a drinking straw. The cap 39 assists in guiding an end of the drinking straw into a beverage container inside the housing 2. The cap 39 also limits air exchange between the temperature chamber and outside environment, thereby improving energy efficiency, protects the beverage in the beverage container from outside contaminants, and prevents splashed beverage from being ejected from the temperature chamber through the tubing port. The cap 39 may optionally be made of disposable materials to facilitate sanitary use of an embodiment of the invention by more than one person.

Some embodiments are equipped with features to prevent the housing from tipping over far enough to cause a beverage spill. For example, some housings have raised bars along both sides. The raised bars fit slidably into channels in a separate carrier or rack. An embodiment of the invention, after being placed in a carrier or rack, is less likely to be tipped over accidentally. Alternatively, slots in the housing may be provided to engage posts attached to a rack or other support structure. Holes may optionally be provided in the housing, through which threaded fasteners pass for attaching the housing to a table, tray, or other support structure. Or, the housing may be fitted with chassis slides to allow an embodiment to be extended from a carrier or a rack without completely disengaging from the carrier or rack.

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, or use of equivalent functional steps for steps described herein. Such insubstantial variations are to be considered within the scope of what is contemplated here. Moreover, if plural examples are given for specific means, or steps, and extrapolation between or beyond such given examples is obvious in view of the present disclosure, then the disclosure is to be deemed as effectively disclosing and thus covering at least such extrapolations.

Unless expressly stated otherwise herein, ordinary terms have their corresponding ordinary meanings within the respective contexts of their presentations, and ordinary terms of art have their corresponding regular meanings.

What is claimed is:

1. An apparatus for heating or cooling a beverage in a beverage container, comprising:
a housing having an outer surface;
a temperature chamber within said housing;
a tubing port between said housing outer surface and said temperature chamber;
a thermoelectric cooler thermally coupled to said temperature chamber and adapted to maintain a selected temperature in said temperature chamber; and
a scale adapted to measure a weight of an object placed in said temperature chamber.

2. The apparatus for heating or cooling a beverage in a beverage container of claim 1, further comprising a plurality of status indicators for communicating a status of the apparatus to a person.

3. The apparatus for heating or cooling a beverage in a beverage container of claim 2, wherein at least one of said status indicator is for communicating information about the beverage to a person.

4. The apparatus for heating or cooling a beverage in a beverage container of claim 3, wherein at least one of said status indicator alerts a person using the apparatus to drink more beverage.

5. The apparatus for heating or cooling a beverage in a beverage container of claim 3, wherein one of said status indicator comprises a display module adapted to display numerical values.

6. The apparatus for heating or cooling a beverage in a beverage container of claim 5, wherein said display module is adapted to display numerical values related to a weight of the beverage.

7. The apparatus for heating or cooling a beverage in a beverage container of claim 6, wherein said display module is adapted to display numerical values related to time.

8. The apparatus for heating or cooling a beverage in a beverage container of claim 7, further comprising a first threshold weight value, wherein one of said status indicator indicates when an amount of weight measured by said scale is less than said first threshold weight value.

9. The apparatus for heating or cooling a beverage in a beverage container of claim 8, further comprising:
a control module comprising:
a data output terminal;
a TEC current terminal; and
a weight data input terminal;
said scale further comprising a weight data output terminal electrically connected to said weight data input terminal; and
said thermoelectric cooler further comprising a supply current terminal electrically connected to said TEC current terminal.

10. The apparatus for heating or cooling a beverage in a beverage container of claim 9, wherein said display module displays a value of time at which a value of weight measured by said scale first becomes less than said first threshold weight value.

11. The apparatus for heating or cooling a beverage in a beverage container of claim 9, wherein said display module displays a duration of time remaining in a selected time interval for a value of weight measured by said scale to become less than said first threshold weight value.

12. The apparatus for heating or cooling a beverage in a beverage container of claim 9, wherein said display module displays a value related to an amount of weight change in a selected time interval.

13. The apparatus for heating or cooling a beverage in a beverage container of claim 9, wherein said display module displays a value related to a temperature in said temperature chamber.

14. The apparatus for heating or cooling a beverage in a beverage container of claim 9, further comprising a flexible arm attached to said housing.

15. The apparatus for heating or cooling a beverage in a beverage container of claim 9, further comprising:
at least one guide rail for limiting a resting position of the beverage container;
a door assembly rotatably connected to an end of the housing; and
a container positioning guide attached to said door assembly.

16. The apparatus for heating or cooling a beverage in a beverage container of claim 15, wherein said guide rails and said container positioning guide cause a beverage container to be located in a preferred position.

17. The apparatus for heating or cooling a beverage in a beverage container of claim 9, wherein said control module controls said fan to reduce a sound intensity measured for said fan.

18. The apparatus for heating or cooling a beverage in a beverage container of claim 9 wherein said control module controls said fan and said thermoelectric cooler to reduce an amount of energy consumption.

19. The apparatus for heating or cooling a beverage in a beverage container of claim 9, wherein said temperature chamber has a size adapted to receive a sixteen-ounce beverage container.

20. The apparatus for heating or cooling a beverage in a beverage container of claim 14, wherein said apparatus weighs less than 15 pounds (7 kilograms).
